(19) United States
(12) Patent Application Publication
(10) Pub. No.: US 2011/0209091 A1
(43) Pub. Date: Aug. 25, 2011

(54) SYSTEM AND METHOD TO MEASURE BANDWIDTH IN HUMAN TO MACHINE INTERFACES

(75) Inventors: Robert Bruno Bucciarelli, Plymouth, MI (US); Wes Albert Nagara, Commerce Township, MI (US); T.C. Wingrove, Canton, MI (US)

(73) Assignee: VISTEON GLOBAL TECHNOLOGIES, INC., Van Buren Township, MI (US)

(21) Appl. No.: 12/712,111

(22) Filed: Feb. 24, 2010

(51) Int. Cl. G06F 3/048; G06F 15/16

(52) U.S. Cl. 715/825; 715/764; 709/230

(57) ABSTRACT

The invention relates to a system and method of measuring bandwidth to determine whether there is a sufficient data rate available to enable or disable features and applications located in a vehicle. Based on the available bandwidth, the system activates or deactivates buttons associated with devices located in the vehicle. Activation and deactivation of the devices are represented on an interface, such as a display, in the vehicle.

### BACKGROUND OF THE INVENTION

1. Technical Field

The invention relates to a system and method of measuring bandwidth, and in particular, to measuring bandwidth to determine whether to connect or disconnect applications and/or devices based on the available bandwidth.

2. Discussion

In today's constantly evolving technology driven world, there are numerous devices and methods in which to communicate information. As these technologies have become increasingly popular and sophisticated, they have made their way into a variety of different areas. One such area is the automotive industry. Current automotive infotainment systems implementing network connections, such as the Internet, in the vehicle do not adapt the Human-to-Machine Interface (HMI), such as buttons, dials, displays, touch-screens or the like, with respect to connectivity bandwidth limitations or issues.

In an environment such as infotainment systems connected to a network, it is important to be able to estimate how much bandwidth is or could be available for a particular use. For example, if insufficient bandwidth is available, then it may not make sense to start a task that would have to be performed inadequately or later aborted. Often the streaming transmission of audio and video information requires a certain quality of service in order to provide a satisfactory user experience, and if that quality of service (QoS) is not available then the user experience will be lacking. For example, in a conversational class of service (i.e. mobile telephony), packets need to arrive at their destination within a minimum time window in order to provide a natural conversational environment. Similarly, packets containing streaming video or music need to arrive with minimum delay variance (jitter) otherwise the decoded video or music will not flow naturally. On the other hand, packets containing an email message or packets containing non-streaming music that is being downloaded can be carried in a background class of service that is less sensitive to packet delays since packet delays on such information have little, if any, perceptual effect. Knowledge of the available bandwidth at an input side of the packet network facilitates a more intelligent control of packet flows into the network, thereby maximizing QoS conformance.

As more and more internet and other “connected” technologies are being integrated into vehicles, it becomes increasingly important to monitor and evaluate bandwidth allocation. However, current methods are not optimized for use in association with the automotive HMI environment such that bandwidth availability helps to control the HMI. Moreover, inefficient HMIs in the automotive environment can be distracting and dangerous to drivers and other vehicles. For example, a slow bandwidth connection that fails to provide audio to the vehicle may distract the driver as he attempts to determine why the device is not working. HMIs for connectivity-dependent applications should be designed to be intuitive and allow the driver to focus on driving.

### SUMMARY OF THE INVENTION

The invention relates to a Human-to-Machine Interface (HMI) for an in-vehicle system that leverages network connectivity, such as the Internet. The system or connecting device determines the bandwidth/connection quality (e.g. 100 kbps, 300 kbps, 1 Mbps, etc.) of service (ex. Bluetooth, WiFi, 2G, 2.5G, 3G, 4G, WiMax, LTE, Ethernet, CAN, MOST, etc. . . . ) that is available. Based on this bandwidth, the system shows the user which features or applications are currently available. Bandwidth service updates, for example to determine quality and availability, can be either periodic or constant. Once information about the connection quality is received, the system then adapts the available HMI options to the current connectivity conditions. Certain features and applications require minimum bandwidth for operation. As the minimum bandwidth requirements are met for each application, the HMI will highlight or inform the user which of the corresponding features/applications are available.

In one embodiment of the invention, there is a method of displaying items on an interface, including measuring bandwidth of a communication over a network, and displaying at least one of the items on the interface based on the measured bandwidth.

In one aspect of the invention, the communication is between and end point and a vehicle.

In another aspect of the invention, the communication is routed through an access point.

In yet another aspect of the invention, the method includes activating the at least one item on the interface when minimum bandwidth requirements are met, and deactivating the at least one item on the interface when minimum bandwidth requirements are not met.

In still another aspect of the invention, wherein activated items are displayed for selection on the interface, and deactivated items are displayed but not accessible on the interface.

In another aspect of the invention, the bandwidth is measured periodically or constantly.

In still another aspect of the invention, the method further includes preventing communication of data for non-essential devices or features to provide maximum bandwidth.

In yet another aspect of the invention, the measurement of bandwidth occurs within a vehicle.

In another aspect of the invention, the measurement of bandwidth is external to a apparatus.

In another embodiment of the invention, there is an apparatus, including a bandwidth measurement device measuring bandwidth of a communication over a network, and an interface displaying at least one item based on the measured bandwidth.

### BRIEF DESCRIPTION OF THE DRAWINGS

The present invention will become more fully understood from the detailed description given here below, the appended claims, and the accompanying drawings in which:

FIG. 1 shows an exemplary interface without connectivity in accordance with the invention.

FIG. 2 shows an exemplary interface with a low data rate connectivity in accordance with the invention.

FIG. 3 shows an exemplary interface with a medium data rate connectivity in accordance with the invention.

FIG. 4 shows an exemplary interface with a high data rate connectivity in accordance with the invention.

FIG. 5 shows an exemplary system with an in-vehicle based monitoring system in accordance with the invention.

FIG. 6 shows an exemplary system with an external based monitoring system in accordance with the invention.

FIG. 7 shows an exemplary wireless communication network between a vehicle and an end point or device.

### DETAILED DESCRIPTION OF THE PREFERRED EMBODIMENT

A system and method is provided for an in-vehicle interface with network connectivity, such as the Internet, or otherwise connectivity-dependent features and applications. Connectivity-dependent features and application, in this context, is a broad term that generally refers to any feature or application that is in the vehicle. For example, the vehicle may include a feature or application to control devices such as satellite radio, a navigation system, mobile phone connectivity, email service, Internet, etc. However, accessing these devices using the features and applications, particularly when driving, can be operationally intensive, non-intuitive, and distracting. In addition, these features and applications often require a large amount of the driver's focus to detect if the feature or application is operating properly. This poses safety issues to the driver, passenger(s) and other vehicles on the road. Additionally, certain non-essential features can be prevented from functioning if they hamper the system performance (for example, the system prohibits advertising, etc.). This will help to free up additional bandwidth.

In conventional systems, a user or driver might select an option to activate an “internet radio” feature. If there is insufficient bandwidth, the device will not play the music the user has requested. According to this invention, and applying the same scenario, the user would not have been able to select the “internet radio” feature from the vehicle HMI. The “internet radio” option would have been “grayed out” due to a lack of bandwidth, which would have been previously determined by the system. In another example, a user might try to enter a destination when there is no “off-board” connectivity. Normally, the system would just “hang” and appear to be looking for the destination. Eventually the system might “time out.” Using this invention, the option for navigation would be “grayed out” as unavailable due to the system determining insufficient bandwidth exists for this feature.

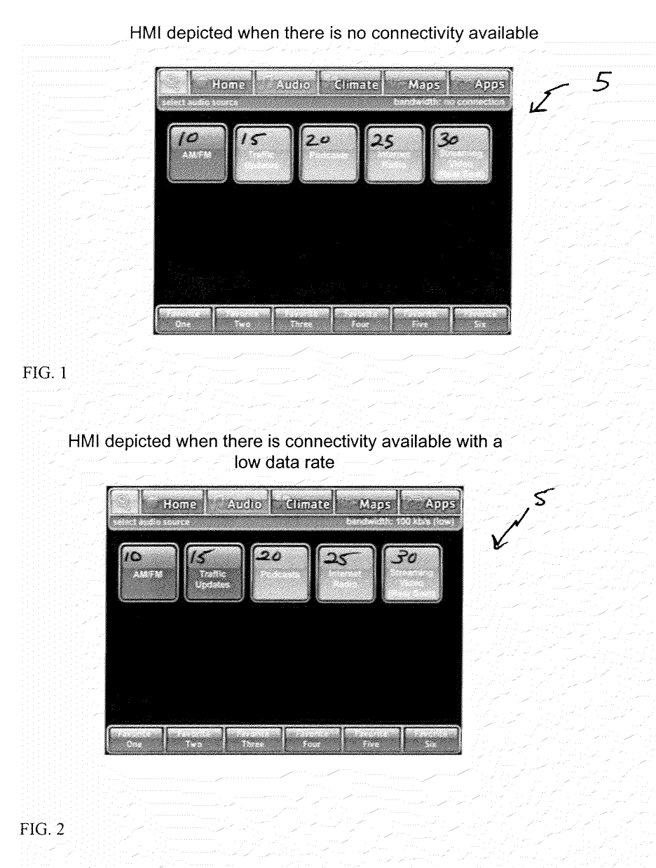

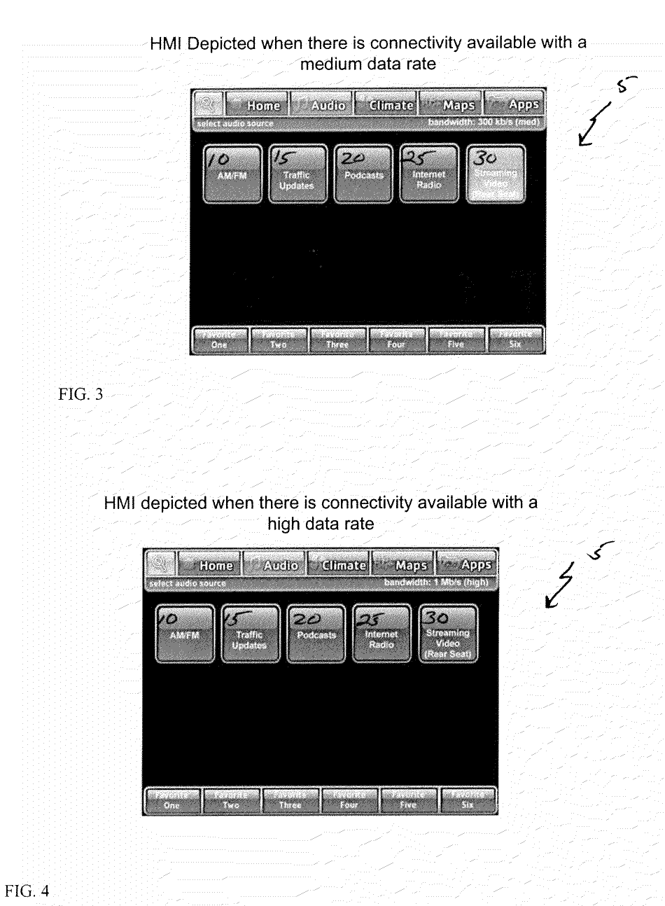

In today's vehicles, features and applications (as briefly described above) are often operated through a single interface, sometimes referred to as a Human-to-Machine Interface (HMI). These in-vehicle interfaces and systems leverage network connectivity, such as the Internet, in order to provide operational capability. The term network, as used herein, is broadly defined to mean any type of network, as readily understood. For example, in one embodiment, the network includes a vehicle in wireless communication with an end point, such as an email server. Although a single interface is often implemented in vehicles, it is understood that this invention is not limited to a single interface, and may include any interface in the vehicle as readily understood. The system connecting device determines the bandwidth/connection quality (e.g. 100 kbps, 300 kbps, 1 Mbps, etc.) of service (ex. Bluetooth, WiFi, 2G, 2.5G, 3G, 4G, WiMax, LTE, Ethernet, CAN, MOST, etc. . . . ) that is available, using known techniques. Available bandwidth, in one example, is conducted by transferring a file of known size and measuring the time taken for the transfer. The throughput is then calculated by dividing the file size by the time taken to transfer the file. Of course, this is merely exemplary in nature, and any known technique may be used. Based on the available bandwidth, the system shows the user which features or applications are currently available (e.g. data is used to dynamically manipulate the HMI of the vehicle's display). For example, FIG. 1 shows an in-vehicle interface without connectivity since no bandwidth is available (or the bandwidth is too low for the devices attempting to connect). In this example, the user has selected the “audio” feature on interface 5. When selected, the audio feature presents five audio options/buttons, namely AM/FM 10, Traffic Updates 15, Podcasts 20, Internet Radio 25 and Streaming Video (Rear Seat) 30. As illustrated, only option/button AM/FM 10 is highlighted since the bandwidth available is not sufficient for the other features or applications 15-30. That is, the system and interface only enables features and applications that the user/driver may access based on the available bandwidth. As a result, the driver will not spend time attempting to access or use any of the features and applications that will not operate. FIGS. 2-4 show an in-vehicle interface with low, medium and high data rate connectivity, respectively. As depicted in each of the drawings (FIGS. 2-4), options/buttons 10-30 are enabled and disabled based on the available bandwidth data rate that is calculated by the system or connecting device, and in accordance with the required minimum bandwidth data rate for the connecting device.

As data rates change, based on a variety of factors, such as environment and location, the system needs to monitor the available bandwidth. Bandwidth monitoring (or service updates), for example to determine quality and availability, may be assumed, periodic or constant. Once information about the connection quality is received, the system then adapts the available HMI options to the current connectivity conditions. That is, the system enables and disables the options/buttons 10-30 according to the available bandwidth. Certain features and applications require minimum bandwidth for operation. As the minimum bandwidth requirements are met for each application, the HMI will highlight or inform the user which of the corresponding features/applications are available, as described above. More specifically, the communication bandwidth will vary based on many conditions (e.g. location, environment, weather, etc). If the minimum bandwidth that is specified for a particular application is achieved, the application is turned on or activated by the HMI. Conversely, if the minimum bandwidth requirements are not met, the feature/service is turned off and the buttons are removed or somehow marked as inactive (e.g. grayed out, red, etc.).

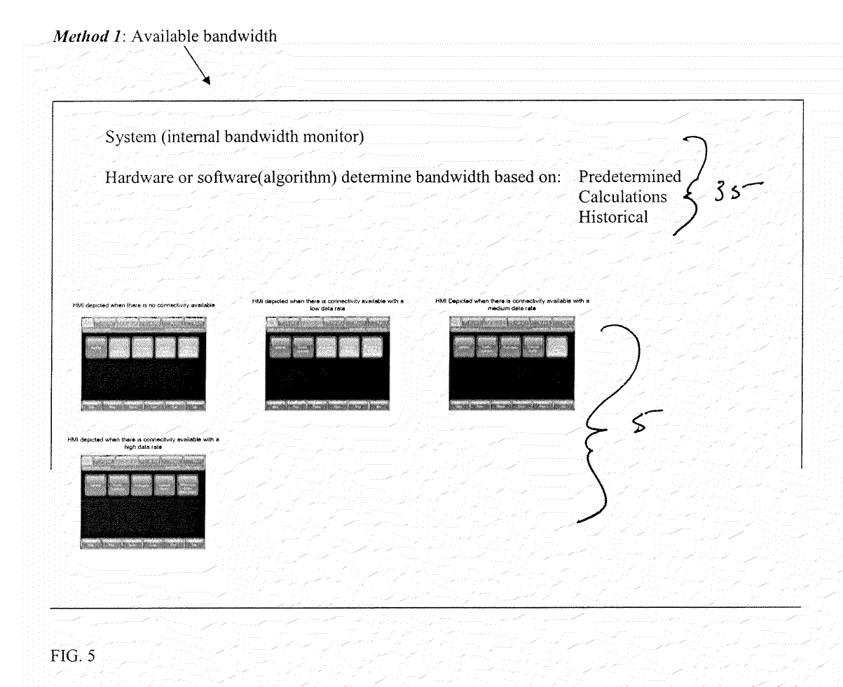

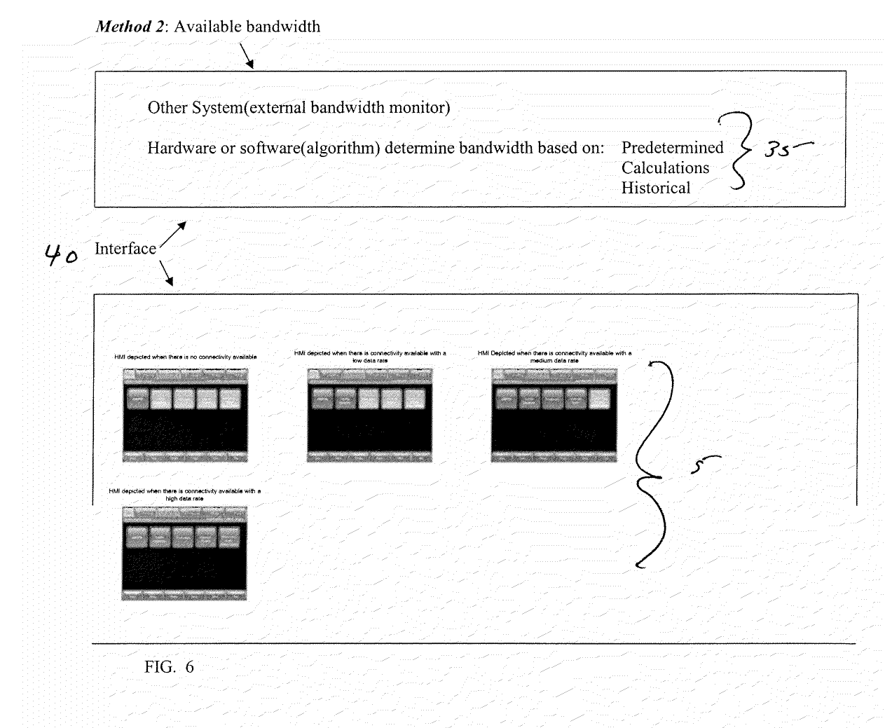

FIG. 5 shows an exemplary system with an in-vehicle monitoring system, and FIG. 6 shows an exemplary system with an external monitoring system. As illustrated in FIGS. 5 and 6, the system that monitors the available communication bandwidth can be accomplished using an internal or external monitoring system (or a combination thereof). This can be accomplished using a software/algorithm or hardware to calculate and/or determine available bandwidth, which dictates whether the system enables or disables features and applications residing on the interface. The bandwidth requirement can be predetermined, calculated, obtained from historical performance data, or any other means readily understood. Bandwidth varies largely depending on a variety of factors which include, but are not limited to, communications technology, mobile, weather, backend network, people on network and their specific data used, etc.

FIG. 5 shows an exemplary system with an in-vehicle monitoring system in accordance with the invention. In this example, the connection bandwidth is monitored at the vehicle end to determined availability. That is, hardware and/or software 35 that is located in the vehicle is responsible for monitoring the available bandwidth and advising the HMI which options/buttons 10-30 to enable and/or disable.

FIG. 6 shows an exemplary system with an external monitoring system in accordance with the invention. In this example, the connection bandwidth is monitored outside of (external) the vehicle. The system hardware and/or software 35 could be located at an end point, or at some location in between the vehicle and the end point. Similar to FIG. 5, hardware and/or software 35 that is located external to the vehicle is responsible for monitoring the available bandwidth and advising the HMI which options/buttons 10-30 to enable and/or disable. In addition, an interface 40 connects the vehicle with the external system 35.

In either the system of FIG. 5 or FIG. 6, the hardware and/or software 35 may determine bandwidth based on predetermined data (e.g. the bandwidth is set in advance), calculations made using known techniques (e.g. the bandwidth is calculated based on various factors) or historical data (e.g. using information based on prior action).

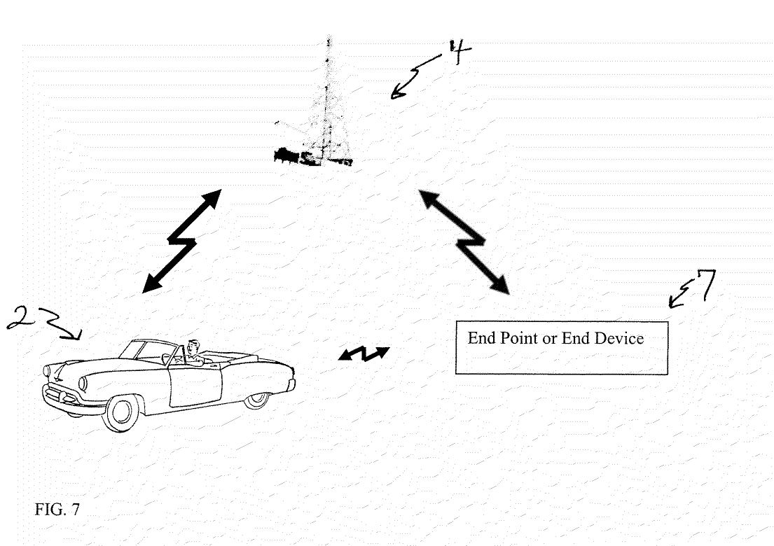

FIG. 7 shows an exemplary wireless communication network between a vehicle and an end point or device. In the exemplary embodiment, vehicle 2 is equipped with an interface 5 that is capable displaying items such as AM/FM 10, Traffic Updates 15, Podcasts 20, Internet Radio 25 and Streaming Video (Rear Seat) 30, etc. In one embodiment, an access point 4, such as a cellular base station, communicates with the vehicle 2 and the end point 7 to transfer data there-between. In another embodiment, the vehicle 2 communicates directly with end point 7. In either event, data is transferred between the vehicle 2 and end point 7 based on available bandwidth, using known protocols. The invention is not limited to the number of access points 4 that may be used, nor is it limited to a cellular base station. Any means of transferring data known in the art may be used, including, but not limited to, satellite, WiMax, Bluetooth, etc.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A method of displaying items on an interface, comprising:
measuring bandwidth of a communication over a network; and
displaying at least one of the items on the interface based on the measured bandwidth.

2. The method of claim 1, wherein the communication is between and end point and a vehicle.

3. The method of claim 2, wherein the communication is routed through an access point.

4. The method of claim 1, further comprising:
activating the at least one item on the interface when minimum bandwidth requirements are met; and
deactivating the at least one item on the interface when minimum bandwidth requirements are not met.

5. The method of claim 4, wherein activated items are displayed for selection on the interface, and deactivated items are displayed but not accessible on the interface.

6. The method of claim 1, wherein the bandwidth is measured periodically or constantly.

7. The method of claim 4, further comprising preventing communication of data for non-essential devices or features to provide maximum bandwidth.

8. The method of claim 1, wherein the measurement of bandwidth occurs within a vehicle.

9. The method of claim 1, wherein the measurement of bandwidth is external to a apparatus.

10. An apparatus, comprising:
a bandwidth measurement device measuring bandwidth of a communication over a network; and
an interface displaying at least one item based on the measured bandwidth.

11. The apparatus of claim 10, wherein the communication is between and end point and a vehicle.

12. The apparatus of claim 11, further comprises an access point through which the communication is routed.

13. The apparatus of claim 10, wherein the at least one item is:
activated on the interface when minimum bandwidth requirements are met; and
deactivated on the interface when minimum bandwidth requirements are not met.

14. The apparatus of claim 13, wherein activated items are displayed for selection on the interface, and deactivated items are displayed but not accessible on the interface.

15. The apparatus of claim 10, wherein the bandwidth is measured periodically or constantly.

16. The apparatus of claim 13, wherein communication of data for non-essential devices or features is prevented to provide maximum bandwidth.

17. The apparatus of claim 10, wherein the measurement of bandwidth occurs within a vehicle.

18. The apparatus of claim 10, wherein the measurement of bandwidth is external to a vehicle.
